(19) United States
(12) Patent Application Publication
(10) Pub. No.: US 2024/0395051 A1
(43) Pub. Date: Nov. 28, 2024

(54) FUNCTIONAL CONTACT LENS AND METHOD FOR DYEING THE SAME

(71) Applicant: AutoSys (TW) Co., Ltd., Zhubei City (TW)

(72) Inventors: Han-Wei Huang, Zhubei City (TW); Bo-Yu Chen, Zhubei City (TW); Tse-Min Chen, Zhubei City (TW); Jui-Li Chen, Zhubei City (TW)

(73) Assignee: AutoSys (TW) Co., Ltd., Zhubei City (TW)

(21) Appl. No.: 18/407,468

(22) Filed: Jan. 9, 2024

(30) Foreign Application Priority Data
May 15, 2023 (TW) 112117905

(51) Int. Cl. G06V 20/58; G06T 7/10; G06V 10/26; G06V 10/82; G06V 20/56

(52) U.S. Cl. CPC G06V 20/58; G06T 7/10; G06V 10/26; G06V 10/82; G06V 20/588; G06T 2207/20021; G06T 2207/20084; G06T 2207/20112; G06T 2207/30252

(57) ABSTRACT

The present invention provides a driving assistance system and a driving assistance computation method that utilize a deep neural network architecture to achieve object detection and semantic segmentation functionalities in a single inference of the same model.

### CROSS-REFERENCE TO RELATED APPLICATION

This non-provisional application claims priority claim under 35 U.S.C. § 119(a) on Taiwan Patent Application No. 112117905 filed May 15, 2023, the entire contents of which are incorporated herein by reference.

### FIELD OF THE INVENTION

This invention relates to a driving assistance system and a computational method for driving assistance, particularly concerning a driving assistance system and a computational method based on deep neural network architecture.

### BACKGROUND OF THE INVENTION

Advanced Driver Assistance Systems (ADAS) predominantly perform tasks related to object detection and image segmentation. Object detection typically identifies categories such as pedestrians, traffic lights, signage, motorcycles, and four-wheeled vehicles, while image segmentation focuses on detecting categories like lane lines and drivable areas.

However, most ADAS require the aforementioned detection and recognition functions, necessitating the use of two different deep-learning model architectures. This not only doubles the inference time but also increases complexity, as image segmentation models are more complex than those for object detection.

For instance, the task of detecting drivable areas primarily relies on image segmentation models. These models typically undergo encoding and decoding processes, and the results of post-model inference involve pixel-by-pixel categorization. This requires additional post-processing steps for grouping and fitting polynomials to identify lane lines and drivable areas.

Based on the above, it is evident that current image segmentation models not only consume considerable time during model inference but also require time-consuming post-processing steps. Eliminating the need for model encoding, decoding, and complex post-processing could significantly reduce the time for the entire detection task. Therefore, integrating the object detection deep learning model architecture to accomplish image segmentation tasks could simplify the complexity of the existing segmentation process, achieving a dual-functionality goal with a single inference.

### SUMMARY OF THE INVENTION

This invention introduces a multi-task detection and recognition technology based on a single deep learning model, encompassing object detection and semantic segmentation. The model employs a block-based image detection and recognition approach, omitting the encoding and decoding architecture. It performs line segment detection in multiple blocks of the image, directly providing polynomial coefficients, categories, and boundary limits for each block's line segment. Thus, the post-processing stage only requires analyzing the relationship of each block with its neighboring segments to determine lane lines and drivable areas, significantly reducing post-processing time.

The invention integrates semantic segmentation and object detection into a single target platform, resulting in fewer layers and, consequently, fewer parameters and reduced memory requirements. This combined architecture also offers quicker inference times and fewer processing operations.

The invention proposes a method suitable for embedded systems, capable of real-time detection of lane lines, drivable areas, and various objects (such as bicycles, cars, pedestrians, traffic signs, and lights) in images. By performing real-time detection of block segments, it extracts the polynomial, category, and boundary limits of each block segment. This saves time that would otherwise be spent on grouping lane line pixels and fitting polynomials in semantic segmentation, and it avoids the impact of confidence levels in end-to-end polynomial lane line detection on the overall line results.

Specifically, this invention provides a driving assistance system characterized by its utilization of a deep neural network architecture for object detection and semantic segmentation. The system comprises an image capture module configured to capture an image; an image segmentation module configured to divide the image into multiple block images; a processing module configured to implement the deep neural network architecture based on these block images, constructing shared feature maps for object detection and semantic segmentation, multiple object boxes, and multiple block line segment parameters, and further configured for filtering and merging based on these block line segment parameters; an output module configured to output information related to object detection and semantic segmentation detection.

In one embodiment, the image capture module of the aforementioned driving assistance system includes at least one RGB camera.

In another embodiment, the processing module of the driving assistance system comprises an object detection module and a line segment detection module. The object detection module is configured to perform an object detection evaluation method, including using the Intersection Over Union (IoU) method for evaluation. The line segment detection module is configured to perform a line segment detection evaluation method, including using Tusimple's metrics for evaluation.

In another embodiment, the deep neural network architecture of the driving assistance system includes an algorithm that comprises a loss function for line segment detection, a loss function used in object detection, and a loss function for object box regression.

This invention also provides a computational method for driving assistance, characterized by utilizing a deep neural network architecture for object detection and semantic segmentation detection. The method includes the following steps: Step S1: Capturing an image; Step S2: Dividing the image into multiple block images; Step S3: Executing the deep neural network architecture based on the block images to construct shared feature maps for multiple object detections and semantic segmentations, multiple object bounding boxes, and multiple block line segment parameters; Step S4: Performing filtering and merging based on these block line segment parameters; Step S5: Outputting information related to object detection and semantic segmentation detection.

In one embodiment, Step S1 involves obtaining the image through at least one RGB camera.

In another embodiment, Step S3 includes executing an object detection evaluation method and a line segment detection evaluation method, where the object detection evaluation method involves using the Intersection Over Union (IoU) method for assessment, and the line segment detection evaluation method includes using Tusimple's metrics for evaluation.

In another embodiment, Step S3 includes implementing an algorithm that comprises a loss function for line segment detection, a loss function used in object detection, and a loss function for object box regression.

This invention utilizes a deep neural network architecture that focuses on the design of the architecture and the loss function, reducing the time spent on the Backbone and Neck of the task detection model. It is suitable for real-time processing in embedded systems and performs the detection of lane lines and drivable areas by dividing the screen into multiple blocks, maintaining a high accuracy rate in multi-task detection.

The invention is based on an object detection architecture and fragment-based line segment detection. By constructing shared feature maps for object detection and semantic segmentation, multiple object boxes, and multiple block line segment parameters, it achieves the functionalities of object detection and semantic segmentation in a single model inference.

To make the above-mentioned and other objectives, features, and advantages of this invention more evident and comprehensible, the following implementation examples are provided in detail, along with accompanying illustrations.

### BRIEF DESCRIPTION OF THE DRAWINGS

FIG. 1 is a system architecture diagram of a driving assistance system according to an embodiment of the invention;

FIG. 2 is a flowchart of the computational method for driving assistance according to an embodiment of the invention;

FIG. 3 is a schematic diagram showing the integration of object detection and semantic segmentation architectures in an embodiment of the invention;

FIG. 4 is a schematic diagram of block-based line segment detection according to an embodiment of the invention;

FIG. 5 is a schematic diagram showing the use of CIOU Loss (Complete IOU Loss) for object box regression loss function in an embodiment of the invention;

FIG. 6 is a schematic diagram illustrating the evaluation method of object detection using Intersection Over Union (IoU) in an embodiment of the invention;

FIG. 7 is a schematic diagram of the line segment detection results in an embodiment of the invention; and

FIG. 8 is a schematic diagram showing test verification results of an embodiment of the invention.

### DETAILED DESCRIPTION OF PREFERRED EMBODIMENTS

To understand the technical features, contents, advantages, and effects achievable by this invention, it is explained in detail below regarding the accompanying drawings and in the form of implementation examples. The diagrams used herein are intended solely for illustrative and explanatory purposes and may not necessarily represent the actual proportions and precise configurations after the implementation of the invention. Therefore, the proportions and configurations shown in the attached diagrams should not be interpreted or construed to limit the scope of the invention in its actual implementation, which is hereby clarified.

### Example 1: Driving Assistance System

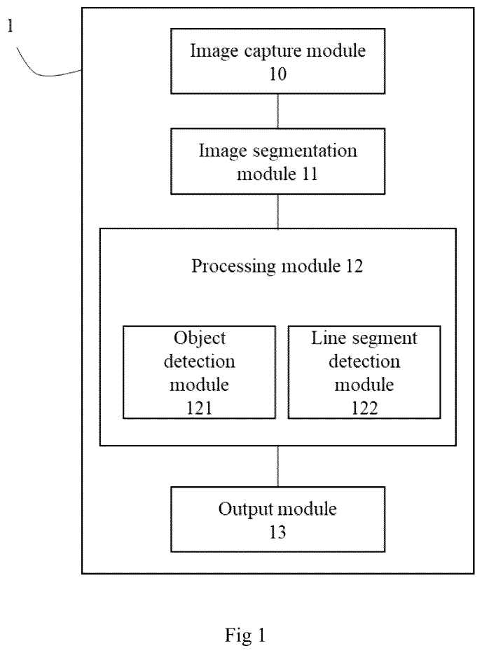

Please refer to FIG. 1, which is a system architecture diagram of a driving assistance system according to an embodiment of this invention. This invention provides a driving assistance system (1), utilizing a deep neural network architecture to perform object detection and semantic segmentation detection. The system includes an image capture module (10), configured to capture an image; an image segmentation module (11), configured to divide the image into multiple block images; a processing module (12), configured to execute the deep neural network architecture based on these block images, thereby constructing shared feature maps for object detection and semantic segmentation, multiple object boxes, and multiple block line segment parameters. The module is further configured to perform filtering and merging based on these block line segment parameters; an output module (13), is configured to output information related to object detection and semantic segmentation detection.

The processing module (12) of the driving assistance system (1) includes an object detection module (121) and a line segment detection module (122). The object detection module (121) is configured to perform an object detection evaluation method, which includes using the Intersection Over Union (IoU) method for evaluation. The line segment detection module (122) is configured to execute a line segment detection evaluation method, which involves using Tusimple's metrics for evaluation.

### Example 2: Computational Method for Driving Assistance

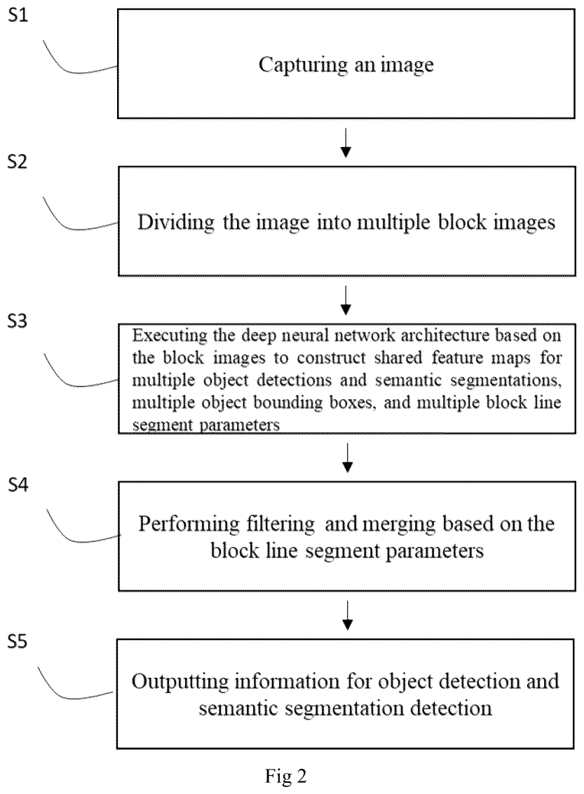

Please refer to FIG. 2, which is a flowchart of the computational method for driving assistance according to an embodiment of this invention. This invention provides a computational method for driving assistance, utilizing a deep neural network architecture to realize object detection and semantic segmentation detection. The method includes the following steps: Step S1: Capturing an image; Step S2: Dividing the image into multiple block images; Step S3: Implementing the deep neural network architecture based on these block images to construct shared feature maps for object detection and semantic segmentation, multiple object boxes, and multiple block line segment parameters; Step S4: Performing filtering and merging based on these block line segment parameters; Step S5: Outputting information related to object detection and semantic segmentation detection.

### Example 3: Integration of Object Detection and Semantic Segmentation Architectures

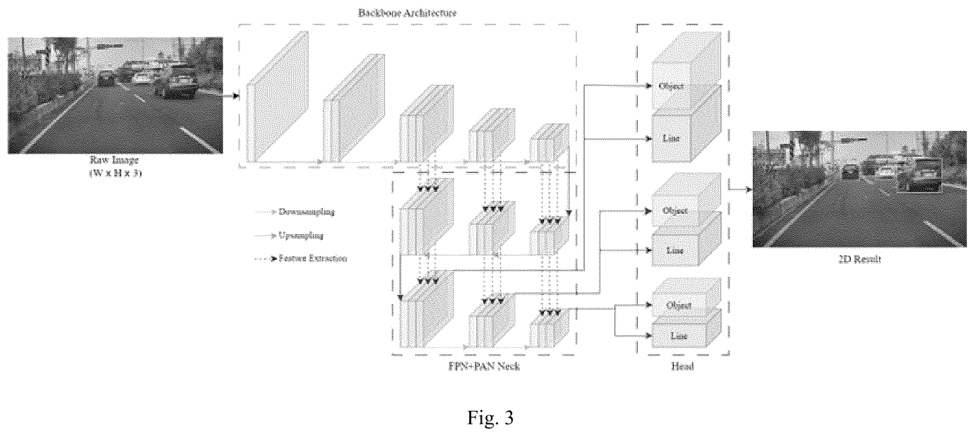

This embodiment presents a deep neural network architecture that integrates object detection and semantic segmentation architectures. As shown in FIG. 3, this architecture enables simultaneous object detection and semantic segmentation using a single deep neural network structure.

Based on the object detection architecture, this embodiment extends to achieve semantic segmentation functionality. Unlike traditional semantic segmentation, which involves pixel-level predictions, this embodiment focuses on detecting the boundaries of semantic segmentation. These boundaries are determined through fragment-based line segment detection, thereby realizing the functionality of semantic segmentation.

Line segment detection involves the parameters of block segments and can be applied in detecting lane lines or boundaries of drivable areas. In this embodiment, the deep neural network architecture performs two tasks: detection and recognition of four-wheeled vehicles and lane line detection. As shown in FIG. 3, the architecture utilizes a Feature Pyramid Network (FPN) combined with a Pixel Aggregation Network (PAN), forming a pyramid network that facilitates the exchange of deep and shallow information within the architecture. To compensate for the inability to localize in the classification architecture, the added network architecture (detection head) includes output information for objects and line segments (semantic segmentation). The extendable object categories include four-wheeled vehicles, two-wheeled vehicles, pedestrians, and traffic lights, while the line segment (semantic segmentation) categories include drivable areas and lane lines.

### Example 4: Block-Based Line Segment Detection Method

During the training phase of line segment detection, it is necessary to first divide the data into different blocks. The size of these blocks is determined by the input size of the architecture and the number of downsampling operations conducted. In this embodiment, the architecture outputs from the detection head after undergoing five downsampling processes, and the input dimensions of the architecture are 640×640. Therefore, the width and height of each block become

$$\frac{640}{\text{?}} \times \frac{640}{\text{?}} ;$$

$$\text{?} \text{indicates text missing or illegible when filed}$$

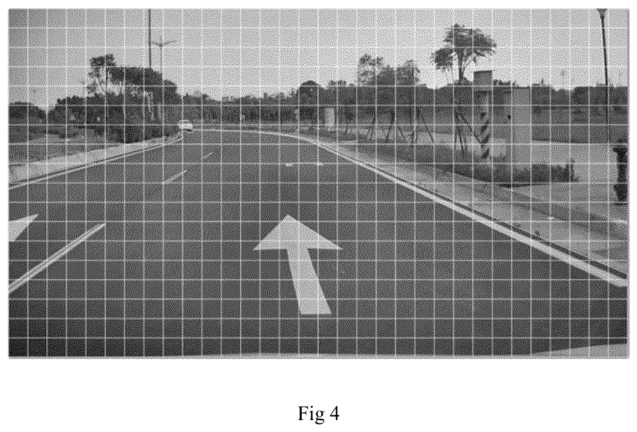

in other words, each block has dimensions of 20×20, as illustrated in FIG. 4.

The loss function for line segment detection (Lineₗₒₛₛ) is outlined in Table 1, including the loss of confidence (cₗₒₛₛ), category loss (clₗₒₛₛ), upper limit loss (upₗₒₛₛ) and lower limit loss (loₗₒₛₛ) of the line segments, and the loss of the line segment itself (xₗₒₛₛ). This loss is calculated based on predicted values obtained through a polynomial estimation model to generate a set of x-values, which are then compared with the correct results (Ground Truth) in the dataset using the Mean Squared Error (MSE) method. This involves squaring the difference between the two values, summing them up, and then calculating the average to serve as the basis for loss regression. The process involves performing MSE loss regression with the predicted values against the Ground Truth.

TABLE 1

| | |
|---|---|
| ${Line}_{loss} = \frac{{\sum }_{f} {c}_{loss}^{Line} ( f ) + {cl}_{loss}^{Line} ( f ) + {up}_{loss}^{Line} ( f ) + {lo}_{loss}^{Line} ( f ) + {x}_{loss}^{Line} ( f )}{mf}$ | (1) |
| cₗₒₛₛ^{Line} = Σᵢ − [ [symbol] · log(pᵢ) + (1 − [symbol] )· log(1 − pᵢ)] | (2) |
| ${cl}_{loss}^{Line} = {\sum }_{i = 0} {\sum }_{ceclasses} - [ ( c ) log ( {p}_{i} ( c ) ) + ( 1 - ( c ) ) log ( 1 - {p}_{i} ( c ) ) ]$ | (3) |
| ${up}_{{loss}^{}}^{Line} = \frac{1}{N} {\sum }_{i}^{N} {( {y}_{i} - {p}_{i} )}^{2}$ | (4) |
| ${lo}_{loss}^{Line} = \frac{1}{N} {\sum }_{i}^{N} {( {y}_{i} - {p}_{i} )}^{2}$ | (5) |
| p(y) = Σₖ₌ₙ^{K} aₖy^{k} | (6) |
| ${x}_{loss}^{Line} = \frac{1}{N} {\sum }_{i = 0} {\sum }_{j = 0}^{N} {( {x}_{i , j} - p ( {y}_{i , j} ) )}^{2}$ | (7) |

The loss function used in object detection (Objₗₒₛₛ), as shown in Table 2, is similar to that in YOLO v5. The loss function for object detection includes the loss of category confidence (cₗₒₛₛ^{Obj}), the loss of object confidence (clₗₒₛₛ^{Obj}), and the loss of object box regression (CIOU).

TABLE 2

| | |
|---|---|
| cₗₒₛₛ^{Obj} = Σᵢ − [ [symbol] · log(pᵢ) + (1 − [symbol] )· log(1 − pᵢ)] | (8) |
| ${cl}_{loss}^{Obj} = {\sum }_{i = 0} {\sum }_{ceclasses} - [ ( c ) log ( {p}_{i} ( c ) ) + ( 1 - ( c ) ) log ( 1 - {p}_{i} ( c ) ) ]$ | (9) |

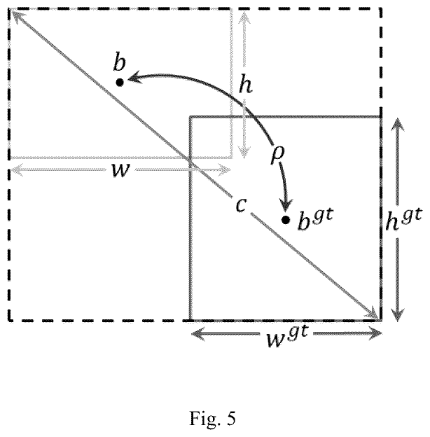

In this invention, the term ‘object box’ refers to the output result of object detection and recognition. The ‘ground truth box’, as mentioned in this invention, refers to the training dataset prepared during the network architecture training phase in Step S1 of the invention. The ‘predicted box’, as referred to in this invention, represents the object detection information output in Step S5 of the invention. The loss function for object box regression employs CIOU Loss (Complete IOU Loss), as shown in Table 3. This loss function considers the distance, overlap rate, scale, and aspect ratio between the ground truth box and the predicted box, as illustrated in FIG. 5, to make the object box regression more stable. The CIOU algorithm, as in formula (10) in Table 3, involves α, a weighting function that can control the size based on the overlap area, as shown in formula (11). ‘v’ measures the consistency of the ratio between the ground truth box and the predicted box, as shown in formula (12) in Table 3.

TABLE 3

| | |
|---|---|
| $v = \frac{4}{{π}^{2}} {( arctan \frac{{w}^{gt}}{{h}^{gt}} - arctan \frac{w}{h} )}^{2}$ | (10) |
| $α = \frac{v}{( 1 - I O U ) + v}$ | (11) |
| $C I O U = 1 - I O U + \frac{{ρ}^{2} ( b , {b}^{gt} )}{{c}^{2}} + α v$ | (12) |

### Example 5: Object Detection Evaluation Method

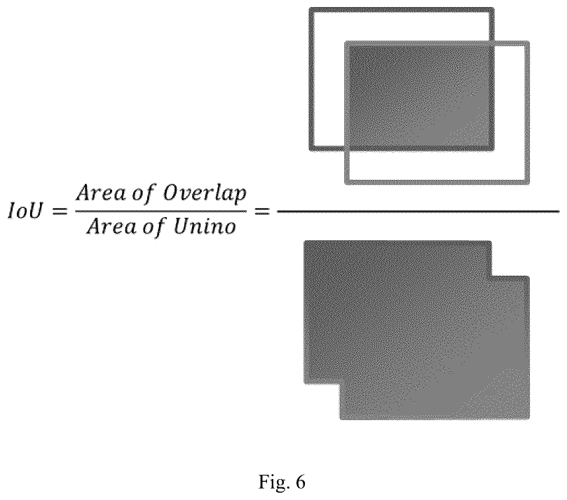

The evaluation method for object detection utilizes the Intersection Over Union (IoU) as a metric. This metric measures the degree of overlap between the predicted bounding box and the annotated data bounding box. As defined in formula (13) shown in Table 4, it calculates the IoU by dividing the area of overlap between the predicted and annotated bounding boxes by the area of the union of these bounding boxes, as illustrated in FIG. 6.

TABLE 4

| | |
|---|---|
| $I o U = \frac{\vert A ⋂ B \vert}{\vert A ⋃ B \vert} = \frac{\vert A ⋂ B \vert}{\vert A \vert + \vert B \vert - \vert A ⋃ B \vert}$ | (13) |

### Example 6: Line Segment Detection Evaluation Method

In this invention, ‘TuSimple’ is identified as a major dataset provider for lane line detection, and its dataset also offers a method for calculating accuracy, as shown in Formula 14 in Table 5. The evaluation method for line segment detection uses TuSimple's metrics, as illustrated in Formula (14) in Table 5, where C_{clip} represents the total number of correctly predicted points, and S_{clip} denotes the total number of actual annotated points. According to these experimental setups, for object detection, the accuracy of the detection results is defined based on an IoU threshold of 0.5. The accuracy of line segment detection is determined by whether the predicted points are within 20 pixels distance from the corresponding annotated points, qualifying them as correctly predicted points.

TABLE 5

| | |
|---|---|
| $Accuracy = \frac{{\sum }_{clip} {C}_{clip}}{{\sum }_{clip} {S}_{clip}}$ | (14) |

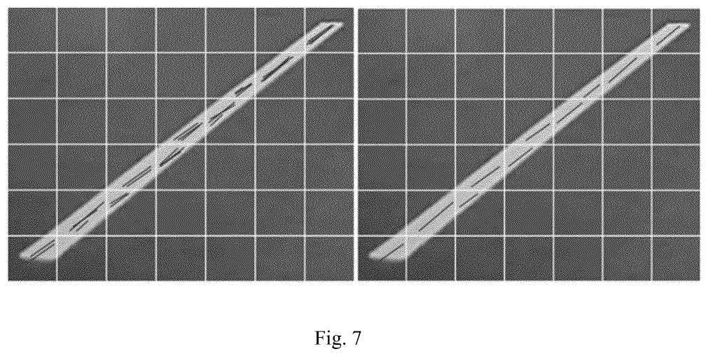

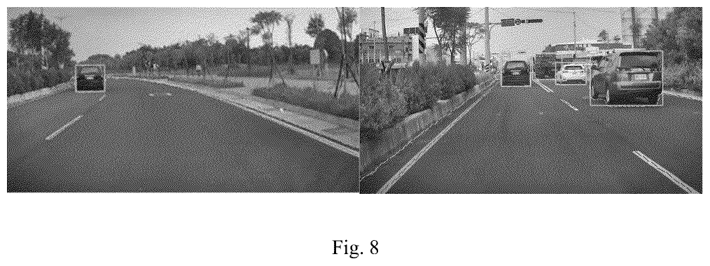

After line segment detection, a lot of similar line segments can appear in the same block, as shown on the left side of FIG. 7. These similar line segments can be filtered through a method called non-maximum suppression, which involves three steps: First, all line segments are sorted from highest to lowest confidence, and the one with the highest confidence is selected as the target. Second, the lower upper limit and the higher lower limit of two line segments are chosen for alignment, and then they are filtered based on a normalized cosine similarity value, filtering out all segments above a set threshold. Third, the line segment with the second-highest confidence is chosen as the target, and steps one and two are repeated until all segments are filtered. The final result, as shown on the right side of FIG. 7, is the block line segments. FIG. 8 shows the results of this embodiment.

The key to this invention is the direct integration of semantic segmentation and object detection into a single network architecture. Since there are various categories in object detection and semantic segmentation, this embodiment exemplifies object detection with four-wheeled vehicles and semantic segmentation with lane line detection. The performance results of accuracy and efficiency, as shown in Table 6, indicate that the average accuracy drops only by about 0.1%, while the inference time is significantly reduced by about 47.9%, making the overall cost-effectiveness approximately 479 times.

TABLE 6

| | AutoSys | Previous | |
|---|---|---|---|
| | Model Merge | approach | ΔDiff |
| Inference Time | 25 ms | 48 ms | A reduction of |
| | | | 47.9% |
| Object Detection | 0.989 | 0.995 | A decrease of |
| Accuracy | | | 0.6% |
| Lane Line Detection | 0.763 | 0.759 | An increase of |
| Accuracy | | | 0.4% |

| | |
|---|---|
| Inference time reduction ratio/Accuracy reduction | (47.9/((0.6-0.4)/2)) = |
| ratio | 479 |

This embodiment compares the AutoSys Model Merge with the previous approach in terms of inference time, object detection accuracy, and lane line detection accuracy. The results are as follows:
Inference Time: The inference time for AutoSys Model Merge is 25 milliseconds, compared to 48 milliseconds for the previous method, a reduction of 47.9%.
Object Detection Accuracy: The accuracy for AutoSys Model Merge is 0.989, compared to 0.995 for the previous method, a decrease of 0.6%. Lane Line Detection Accuracy: The accuracy for AutoSys Model Merge is 0.763, compared to 0.759 for the previous method, an increase of 0.4%.

Based on these results, the ratio of the reduction in inference time to the decrease in accuracy is calculated as (47.9/((0.6−0.4)/2))=479. This shows that AutoSys Model Merge significantly reduces inference time while only slightly decreasing accuracy.

Although the present invention has been disclosed in the embodiments as described above, it is not intended to limit the invention. Those skilled in the art within the field of this invention can make minor modifications and refinements without departing from the spirit and scope of this invention. Therefore, the scope of protection of this invention should be defined by the claims set forth hereafter.

What is claimed is:

1. A driving assistance system characterized by utilizing a deep neural network architecture for performing object detection and semantic segmentation recognition, the system comprising:
an image capture module configured to capture an image;
an image segmentation module configured to divide the image into multiple block images;
a processing module configured to execute the deep neural network architecture based on the block images to construct shared feature maps for multiple object detections and semantic segmentations, multiple object bounding boxes, and multiple block line segment parameters, and further configured to perform filtering and merging based on the block line segment parameters; and
an output module configured to output information for object detection and semantic segmentation detection.

2. The system of claim 1, wherein the image capture module comprises at least one RGB camera.

3. The system of claim 1, wherein the processing module includes an object detection module and a line segment detection module, the object detection module configured to perform an evaluation method for object detection, which includes using the Intersection Over Union (IoU) method for evaluation, and the line segment detection module configured to perform an evaluation method for line segment detection, which includes using Tusimple benchmarks for evaluation.

4. The system of claim 1, wherein the deep neural network architecture includes implementing an algorithm, the algorithm comprising a loss function for line segment detection, a loss function used in target detection, and a loss function for object bounding box regression.

5. A method for driving assistance computation characterized by utilizing a deep neural network architecture for performing object detection and semantic segmentation recognition, the method comprising the steps of:
Step S1: capturing an image;
Step S2: dividing the image into multiple block images;
Step S3: executing the deep neural network architecture based on the block images to construct shared feature maps for multiple object detections and semantic segmentations, multiple object bounding boxes, and multiple block line segment parameters;
Step S4: performing filtering and merging based on the block line segment parameters; and
Step S5: outputting information for object detection and semantic segmentation detection.

6. The method of claim 5, wherein step S1 involves obtaining the image through at least one RGB camera.

7. The method of claim 5, wherein step S3 includes performing an evaluation method for object detection and a line segment detection evaluation method, the object detection evaluation method including using the Intersection Over Union (IoU) method for evaluation, and the line segment detection evaluation method including using Tusimple benchmarks for evaluation.

8. The method of claim 5, wherein step S3 includes implementing an algorithm, the algorithm comprising a loss function for line segment detection, a loss function used in target detection, and a loss function for object bounding box regression.
